(19) United States
(12) Patent Application Publication
(10) Pub. No.: US 2010/0098238 A1
(43) Pub. Date: Apr. 22, 2010

(54) CALL STATUS REENACTMENT DEVICE AND CALL STATUS REENACTMENT METHOD

(75) Inventors: Mamoru Goto, Kawasaki (JP); Hiroshi Hoya, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/573,938

(22) Filed: Oct. 6, 2009

(30) Foreign Application Priority Data
Oct. 16, 2008 (JP) 2008-267430

(51) Int. Cl. H04M 3/42

(52) U.S. Cl. 379/215.01

(57) ABSTRACT

A phone call status reenactment device for reenacting connection status of a phone call includes a storage and a display unit. The storage stores event data for each event in which connection status of a phone call has changed. The event data includes time data indicating a time when the connection status changed and type data indicating a type of event. The display unit displays data on connection status in response to an instruction. The data on connection status is displayed in order of time in accordance with the event data stored in the storage. The data on connection status includes a quantity of phone calls before answered by a phone call taker, a quantity of phone calls ended without answered by a phone call taker, and a quantity of phone calls answered by a phone call taker.

### CROSS-REFERENCE TO RELATED APPLICATION

This application is based upon and claims the benefit of priority of the prior Japanese Patent Application No. 2008-267430, filed on Oct. 16, 2008, the entire contents of which are incorporated herein by reference.

### FIELD

The embodiments discussed herein are related to a technology of computer telephony integration (CTI).

### BACKGROUND

As is well known, there is a telephony system as a system for an organization such as a company and a government institution to treat phone calls received from customers. The telephony system mainly includes a private branch exchange (PBX) machine, an automatic call distribution (ACD) machine, and an interactive voice response (IVR) machine. In the telephony system, when receiving a phone call from a customer, first, the IVR automatically performs voice response. And then, when the phone call received from the customer may not be treated by automatic voice response (AVR), the ACD selects an appropriate call taker, and the PBX connects the customer call to the selected call taker.

In this type of telephony system, data on customer treatment such as date and time of receiving a phone call, date and time of ending a phone call, and an extension number is often stored as log data for CTI. This type of log data may allow an operational plan including a quantity of call takers, their operational hours, and the like, to be appropriately modified (see, for example, Japanese Laid-open Patent Publication No. 2004-023175, Japanese Laid-open Patent Publication No. 2006-254094, Japanese Laid-open Patent Publication No. 2003-167981, or Japanese Laid-open Patent Publication No. 2002-297848).

### SUMMARY

According to an aspect of the present invention, provided is a phone call status reenactment device for reenacting connection status of a phone call. The phone call status reenactment device includes a storage and a display unit.

The storage stores event data for each event in which connection status of a phone call has changed. The event data includes time data indicating a time when the connection status changed and type data indicating a type of event.

The display unit displays data on connection status in response to an instruction. The data on connection status is displayed in order of time in accordance with the event data stored in the storage. The data on connection status includes a quantity of phone calls before answered by a phone call taker, a quantity of phone calls ended without answered by a phone call taker, and a quantity of phone calls answered by a phone call taker.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a telephony system according to an embodiment of the present invention;

FIG. 2 is a diagram illustrating an example of a data configuration of a log table according to an embodiment of the present invention;

FIG. 3 is a diagram illustrating an example of a configuration of a management machine according to an embodiment of the present invention;

FIG. 4 is a diagram illustrating an example of a data configuration of an event table according to an embodiment of the present invention;

FIGS. 5 and 6 are flowcharts illustrating an operation flow of a main routine of a playback tool according to an embodiment of the present invention;

FIG. 7 is a diagram illustrating an example of a playback screen according to an embodiment of the present invention;

FIG. 8 is a diagram illustrating an example of a data configuration of a first work table according to an embodiment of the present invention;

FIG. 9 is a diagram illustrating an example of a data configuration of a second work table according to an embodiment of the present invention;

FIG. 10 is a diagram illustrating an example of a data configuration of a third work table according to an embodiment of the present invention;

FIG. 11 is a flowchart illustrating an operation flow of a playback subroutine according to an embodiment of the present invention;

FIGS. 12 and 13 are flowcharts illustrating an operation flow of a work table update subroutine according to an embodiment of the present invention; and

FIG. 14 is a diagram illustrating an example of a screen including a frequency distribution graph according to an embodiment of the present invention.

### DESCRIPTION OF EMBODIMENTS

By using log data stored in a conventional telephony system, it is not possible to visually reenact the overall condition of past incoming calls received from customers and past call treatment conditions performed by the call takers. Therefore, there is a problem that the operational plan may not be modified in detail.

It is preferable to visually reenact the overall condition of past incoming calls received from customers and the past treatment conditions performed by the call takers.

Hereinafter, a telephony system as an embodiment of a call status reenactment device according to the present invention will be discussed with reference to the accompanying drawings.

The telephony system discussed below is only an example, and the call status reenactment device is not limited to be configured as discussed below.

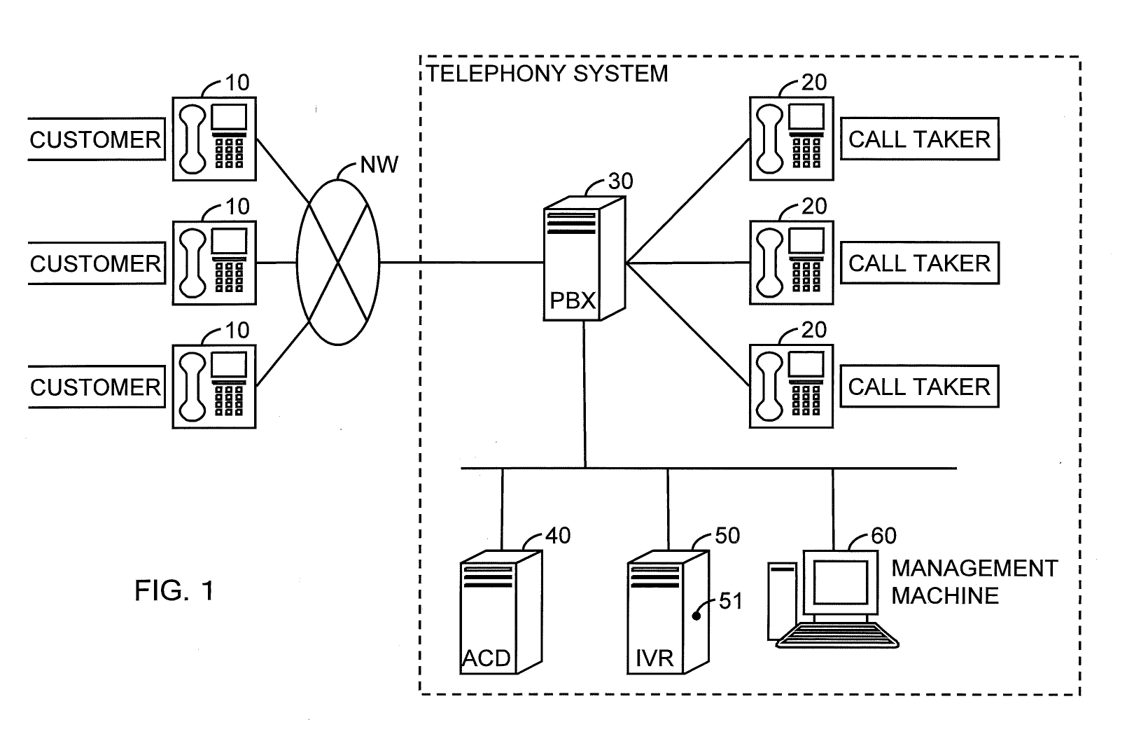

FIG. 1 is a diagram illustrating an example of a configuration of a telephony system according to an embodiment of the present invention.

The telephony system according to the embodiment is a system for an organization such as a company and a government institution to treat phone calls received from customers. The telephony system may be installed in a contact center or call center of the organization. The telephony system is connected to a plurality of telephones 10 used by customers via a telephone network NW.

The telephony system includes a plurality of telephones 20, a PBX machine 30, an ACD machine 40, an IVR machine 50, and a management machine 60. Among them, the PBX machine 30, the ACD machine 40, the IVR machine 50, and the management machine 60 are communicably connected to each other.

The plurality of telephones 20 are telephones used by a plurality of the call takers (telephone operators, telecommunicators) respectively. The plurality of telephones 20 are connected to the PBX machine 30 via extension lines. In this embodiment, the call takers are divided into groups for each of a plurality of contact points of the organization using the telephony system.

The PBX machine 30 is an in-plant switching equipment for switching connections between external lines and extension lines or switching connections between extension lines themselves. When the PBX machine 30 according to the embodiment receives a ringing signal from a telephone exchange in the telephone network NW which receives a selection signal based on a dialing operation from a customer's telephone 10, the PBX machine 30 connects the external line through which the ringing signal is transmitted to the IVR machine 50. Hereinafter, a phone call for which a ringing signal has been received, in other words, a received call is also referred to as an incoming call.

The ACD machine 40 is a computer in which software and hardware for realizing the ACD function are installed. When receiving a request from the IVR machine 50, the ACD function selects a call taker who is not performing call treatment for a customer, from a group corresponding to the telephone number (in other words, contact point) of the external line from which the incoming call is received, in accordance with a predefined logic.

The IVR machine 50 is a computer in which software and hardware for realizing the AVR function are installed. The AVR function is a function which receives a dialing operation from a caller (customer) who makes a phone call, and automatically outputs a voice having a content corresponding to the received dialing operation to the caller. When a need for a call taker to talk with the caller (customer) arises as a result of a dialing operation received from the caller (customer), the IVR machine 50 requests the ACD machine 40 to select a call taker. When the ACD machine 40 selects a call taker, the IVR machine 50 transmits an extension ringing signal to a telephone 20 of the selected call taker via the PBX machine 30. When the IVR machine 50 receives a connection signal from the telephone 20 to which the IVR machine 50 has output the extension ringing signal, the IVR machine 50 requests the PBX machine 30 to connect the extension line of the telephone 20 to the external line connected to the caller. When assuming that a period from the incoming to the clear-back is one phone call, the IVR machine 50 of the embodiment has a function for storing call data on the phone call in a log table 51 as a log. Here, the term clear-back denotes that a clear-back signal is transmitted from the telephone 20, that is, the call taker hangs up the phone.

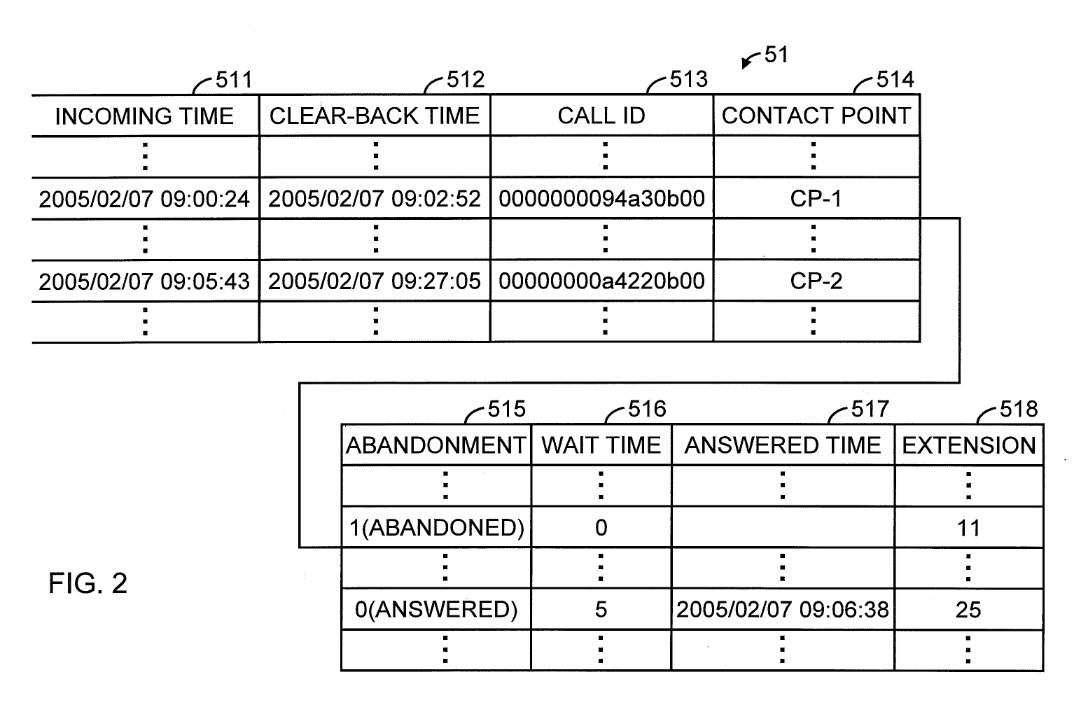

FIG. 2 is a diagram illustrating an example of a data configuration of a log table according to an embodiment of the present invention. As illustrated in FIG. 2, each record of the log table 51 has at least an “INCOMING TIME” field 511 and a “CLEAR-BACK TIME” field 512, contents of which identify one phone call.

The “INCOMING TIME” field 511 stores the date and time of incoming.

The “CLEAR-BACK TIME” field 512 stores the date and time of clear-back.

Also, as illustrated in FIG. 2, the log table 51 has a “CALL ID” field 513, a “CONTACT POINT” field 514, an “ABANDONMENT” field 515, a “WAIT TIME” field 516, an “ANSWERED TIME” field 517, and an “EXTENSION” field 518.

The “CALL ID” field 513 stores a call identifier (ID) which is capable of identifying the phone call.

The “CONTACT POINT” field 514 stores contact point identifier capable of identifying a contact point.

The “ABANDONMENT” field 515 stores abandonment data indicating whether the phone call had ended without answered by a call taker.

The “WAIT TIME” field 516 stores a wait time from the completion of the AVR to the start of a talk with a call taker when a talk with a call taker is needed.

The “ANSWERED TIME” field 517 stores the date and time when the call taker answered the phone call.

The “EXTENSION” field 518 stores an extension number of the telephone 20 via which the call treatment for the phone call was performed. Each record of the log table 51 may include fields other than the fields illustrated in FIG. 2. The log table 51 may be a log table generated for CTI in a conventional telephony system, or may be a log table generated separately for the embodiment.

In the telephony system of the embodiment, although the ACD function and the AVR function are respectively incorporated into the machines 40 and 50 separated from the PBX machine 30, the both functions may be incorporated into the PBX machine 30. Alternatively, only the ACD function may be incorporated into the PBX machine 30, or only the AVR function may be incorporated into the PBX machine 30.

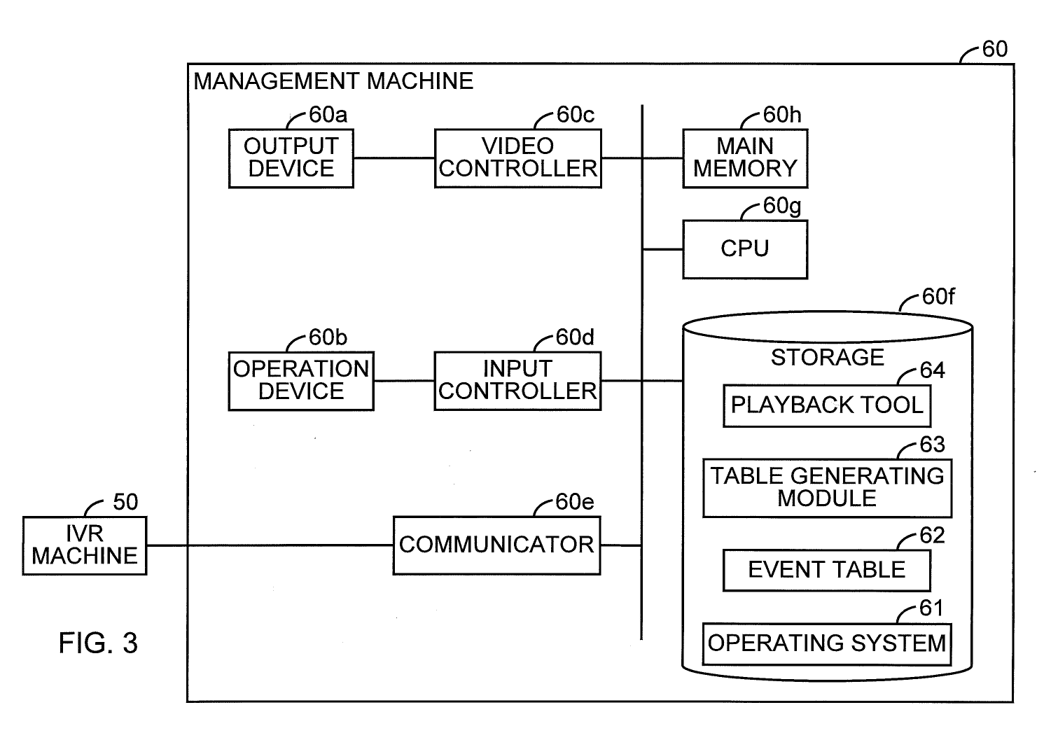

FIG. 3 is a diagram illustrating an example of a configuration of a management machine according to an embodiment of the present invention.

The management machine 60 is a computer in which a function is installed for dynamically displaying changes, in order of time, in a connection status of a phone call which has been treated by the telephony system, as necessary information for managing the contact center. For example, data on connection status of a phone call may be displayed in order of time. The management machine 60 includes an output device 60a, an operation device 60b, and a main body to which the devices 60a and 60b are connected. Here, the output device 60a is a device such as a liquid crystal display equipped with a speaker, and the operation device 60b is a device such as a keyboard, mouse, or the like. The main body houses a video controller 60c, an input controller 60d, a communicator 60e, a storage 60f, a central processing unit (CPU) 60g, and a main memory 60h.

The video controller 60c is a unit for generating an audio-visual signal on the basis of video data (audio-visual data) transferred from the CPU 60g, and outputting the signal to the output device 60a. The input controller 60d is a unit for receiving an operation signal from the operation device 60b and notifying the CPU 60g of the signal.

The communicator 60e is a unit for transmitting/receiving data to/from communicators in the PBX machine 30, the ACD machine 40, and the IVR machine 50. As the communicator 60e, there are an Ethernet (trademark of Xerox Corporation USA) card, a fiber channel (FC) card, an asynchronous transfer mode (ATM) card, a token ring card, a fiber-distributed data interface (FDDI) card, and the like.

The storage 60f is a unit for readably and writably storing various programs and various data in a recording media. As the storage 60f, there are a solid state drive, a hard disk drive, a digital versatile disk (DVD) drive, a +R/+RW drive, and a blu-ray disk (BD) drive. As the recording media, there are a silicon disk including a non-volatile semiconductor memory (flash memory), a hard disk, a DVD (including a DVD-R [recordable], a DVD-RW [rewritable], a DVD-ROM [read only memory], and a DVD-RAM [random access memory]), a +R/+RW, or a BD (including a BD-R, a BD-RE [rewritable], and a BD-ROM).

The CPU 60g is a unit for performing processes in accordance with the programs stored in the storage 60f. The main memory 60h is a unit in which the CPU 60g caches programs and data or lays out a work area.

The management machine 60 stores an operating system 61, an event table 62, a table generating module 63, and a playback tool 64 in the storage 60f.

The operating system 61 is software for performing mediation between software and hardware, memory space management, file management, process management and task management, and the like. The operating system 61 includes a communication interface which is not illustrated in the figures. The communication interface is a program for transmitting/receiving data to/from a communication interface of another computer connected via the communicator 60e. As the communication interface, there are a Transmission Control Protocol/Internet Protocol (TCP/IP) suite, and the like.

The event table 62 stores data necessary for dynamically displaying changes, in order of time, in a connection status of a phone call which has been treated by the telephony system. In the above discussed log table 51, the call data on one phone call is stored as one record. On the other hand, in the event table 62, a change in connection status of a phone call such as incoming, answered, and clear-back is defined as an event, and event data on one event is stored as one record. The event data includes time data and type data. The time data indicates a time when the connection status changed. The type data indicates a type of event such as incoming, answered, and clear-back.

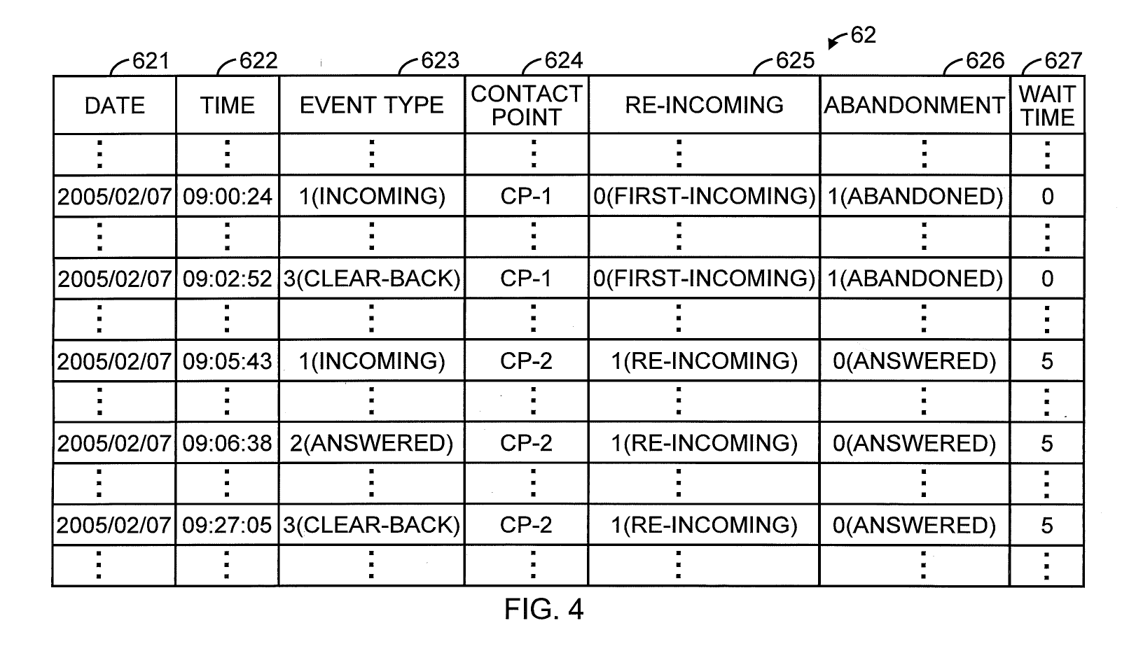

FIG. 4 is a diagram illustrating an example of a data configuration of an event table according to an embodiment of the present invention.

As illustrated in FIG. 4, each record of the event table 62 has “DATE” field 621, “TIME” field 622, “EVENT TYPE” field 623, “CONTACT POINT” field 624, “RE-INCOMING” field 625, “ABANDONMENT” field 626, and “WAIT TIME” field 627.

The “DATE” field 621 stores year, month, and day as date data indicating the date when the event occurred.

The “TIME” field 622 stores hour, minute, and second as time data indicating the time when the event occurred.

The “EVENT TYPE” field 623 stores type data indicating the type of event. In the embodiment, the type data is represented by one of numerals “1” to “3”. The numeral “1” indicates an incoming type event, the numeral “2” indicates an answered type event, and the numeral “3” indicates a clear-back type event. As discussed above, the incoming type event corresponds to a reception of a ringing signal. The clear-back type event corresponds to a transmission of a clear-back signal from the telephone 20 triggered by an on-hook operation of a call taker. The answered type event corresponds to a transmission of a connection signal from the telephone 20 triggered by an off-hook operation of a call taker.

The “CONTACT POINT” field 624 stores contact point identifier capable of identifying the contact point of the incoming call of the event.

The “RE-INCOMING” field 625 stores re-incoming call data indicating whether the caller of the phone call of the event has made another incoming call on the same day. In the embodiment, the re-incoming call data is represented by either of numerals “0” and “1”. The numeral “0” indicates that the caller of the phone call of the event has not made another incoming call on the same day, in other words, this incoming call is the first-incoming call of the day from the caller. The numeral “1” indicates that the caller of the phone call of the event has made another incoming call on the same day, in other words, this incoming call is the second or later incoming call of the day from the caller.

The “ABANDONMENT” field 626 stores abandonment data indicating whether the phone call had ended without answered by a call taker. In the embodiment, the abandonment data is represented by either of numerals “0” and “1”. The numeral “0” indicates that a call taker answered the phone call. The numeral “1” indicates that the phone call had ended without answered by a call taker, in other words, the customer abandoned trying to talk with a call taker. However, the abandonment may also mean that the customer decided not to talk with a call taker because the customer treatment was performed by the AVR.

The “WAIT TIME” field 627 stores the wait time from the completion of the AVR to the start of a talk with a call taker.

Returning to FIG. 3, the table generating module 63 is a program for generating the event table 62 from the log table 51 stored in the IVR machine 50. The table generating module 63 is executed by the CPU 60g, for example, once a day. The table generating module 63 causes the CPU 60g to obtain the log table 51 from the IVR machine 50, and to extract two or more event data items from one record. The table generating module 63 causes the CPU 60g to rearrange the extracted event data items in order of the date and time when the event occurred so as to generate the event table 62. The table generating module 63 may cause the CPU 60g to generate records of the event table 62 on the basis of all records of the log table 51. Alternatively, the table generating module 63 may cause the CPU 60g to extract unprocessed records of the log table 51 as a difference, and to generate records of the event table 62 on the basis of the extracted records. In FIG. 2, two records are clearly illustrated as representative examples, and in FIG. 4, records of the event data generated on the basis of the two records are illustrated.

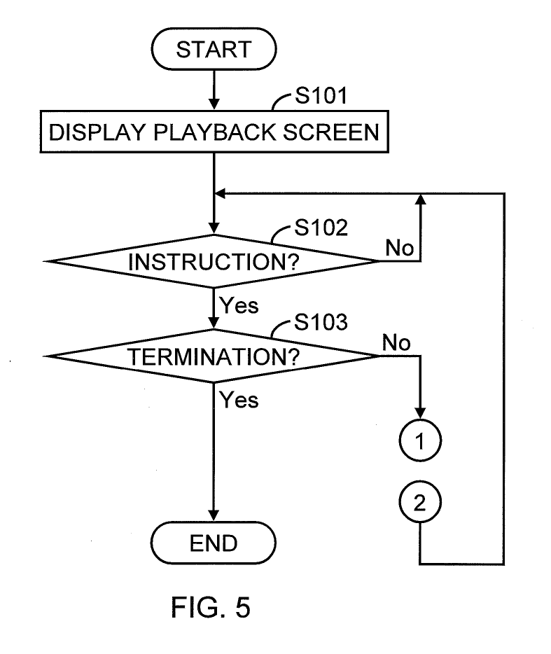

The playback tool 64 is a program for adding to a computer a function for dynamically displaying changes, in order of time, in a connection status of a phone call which has been treated by the telephony system. The playback tool 64 may be executed by the CPU 60g being triggered by, for example, an execution instruction from an operator who operates the operation device 60b. Contents of a process defined in the playback tool 64 will be discussed below with reference to FIGS. 5 to 14.

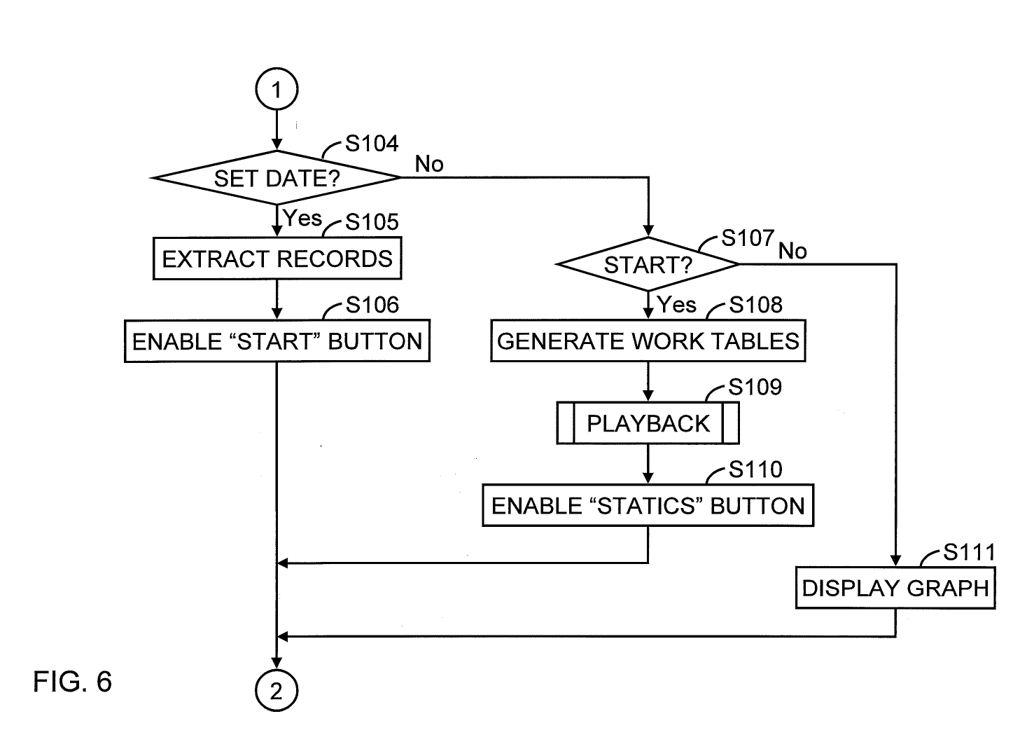

FIGS. 5 and 6 are flowcharts illustrating an operation flow of a main routine of a playback tool according to an embodiment of the present invention.

After starting the main routine, in the first operation S101, the CPU 60g displays a playback screen on the output device 60a.

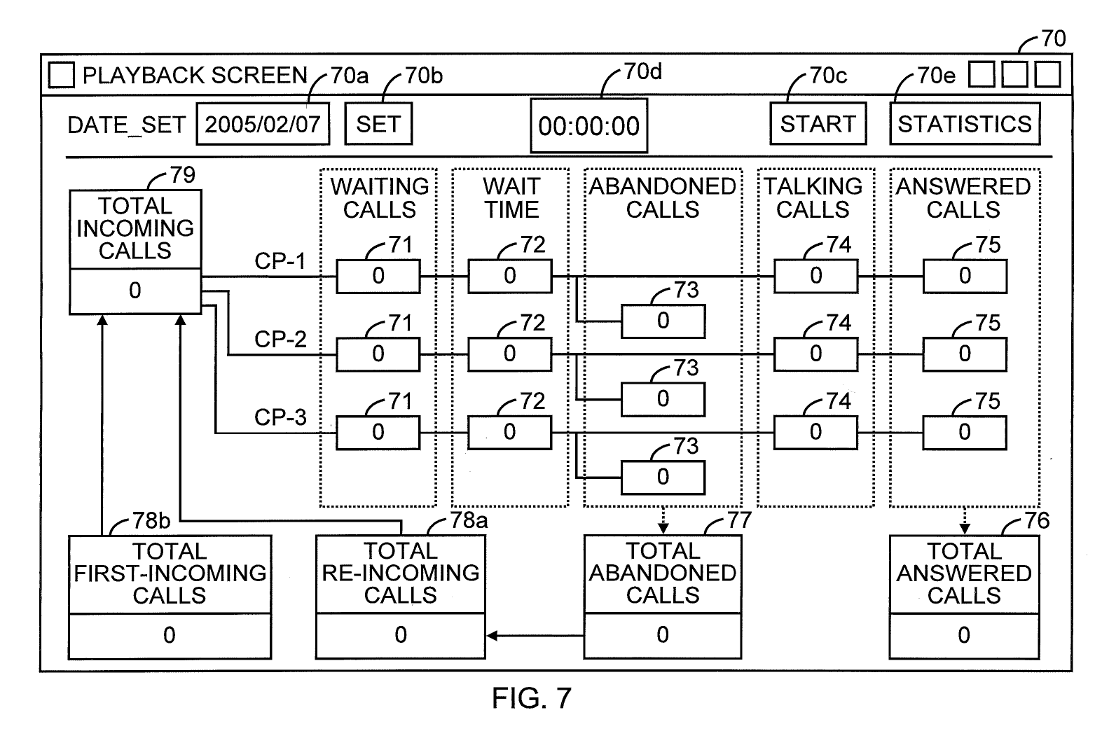

FIG. 7 is a diagram illustrating an example of a playback screen according to an embodiment of the present invention.

The playback screen 70 illustrated in FIG. 7 includes a date input field 70a, a “SET” button 70b, a “START” button 70c, a playback time display field 70d, and a “STATISTICS” button 70e.

The date input field 70a is a field for inputting any date in the past.

The “SET” button 70b is a button for setting a reenactment date, on which the changes in a connection status of a phone call are dynamically displayed, to the date inputted into the date input field 70a.

The “START” button 70c is a button for starting a playback process for dynamically displaying changes, in order of time, in a connection status of a phone call treated on the set date.

The playback time display field 70d is a display field in which hours, minutes, and seconds are displayed as the time of a reenacting point on the set date. Here, the term a reenacting point denotes a time point when a connection status of a phone call is displayed by the playback process.

The “STATISTICS” button 70e is a button for displaying frequency distribution of the phone calls on the set date as a graph.

The playback screen 70 illustrated in FIG. 7 also includes a “WAITING CALLS” display field 71, a “WAIT TIME” display field 72, “ABANDONED CALLS” display field 73, “TALKING CALLS” display field 74, “ANSWERED CALLS” display field 75 in order to display a connection status of a phone call by the playback process. The playback screen 70 illustrated in FIG. 7 also has sets of these display fields 71 to 75, and a quantity of the sets is the same as a quantity of contact points of the organization which uses the telephony system.

The “WAITING CALLS” display field 71 is a display field in which a quantity of waiting calls at the time of the reenacting point in the contact point is displayed. Here, the term a waiting call denotes a phone call in a status after incoming and before answered by a call taker (including a status in which the phone call is treated by the AVR).

The “WAIT TIME” display field 72 is a display field in which a wait time related to a call incoming at the reenacting point in the contact point is displayed.

The “ABANDONED CALLS” display field 73 is a display field in which the total quantity of phone calls abandoned between the start time and the time of the reenacting point in the contact point is displayed. Here, the term an abandoned call denotes a phone call which had ended without answered by a call taker.

The “TALKING CALLS” display field 74 is a display field in which a quantity of talking calls at the time of the reenacting point in the contact point is displayed. Here, the term a talking call denotes a phone call in a status of answered by a call taker and a customer is talking with the call taker.

The “ANSWERED CALLS” display field 75 is a display field in which the total quantity of phone calls answered between the start time and the time of the reenacting point in the contact point is displayed. Here, the term an answered call denotes a phone call which has been answered by a call taker.

The playback screen 70 illustrated in FIG. 7 also includes a “TOTAL ANSWERED CALLS” display field 76, a “TOTAL ABANDONED CALLS” display field 77, a “TOTAL RE-INCOMING CALLS” display field 78a, A “TOTAL FIRST-INCOMING CALLS” display field 78b, and a “TOTAL INCOMING CALLS” display field 79.

The “TOTAL ANSWERED CALLS” display field 76 is a display field in which the total quantity of phone calls answered between the start time and the time of the reenacting point in all the contact points is displayed. Therefore, the sum of the quantities displayed in the “ANSWERED CALLS” display field 75 of each contact point is displayed in the “TOTAL ANSWERED CALLS” display field 76.

The “TOTAL ABANDONED CALLS” display field 77 is a display field in which the total quantity of phone calls abandoned between the start time and the time of the reenacting point in all the contact points is displayed. Therefore, the sum of the quantities displayed in the “ABANDONED CALLS” display field 73 of each contact point is displayed in the “TOTAL ABANDONED CALLS” display field 77.

The “TOTAL RE-INCOMING CALLS” display field 78a is a display field in which the total quantity of second or later incoming calls out of the phone calls on which an incoming type event is performed between the start time and the time of the reenacting point is displayed.

The “TOTAL FIRST-INCOMING CALLS” display field 78b is a display field in which the total quantity of first-incoming calls out of the phone calls on which an incoming type event is performed between the start time and the time of the reenacting point is displayed.

The “TOTAL INCOMING CALLS” display field 79 is a display field in which the total quantity of the phone calls on which an incoming type event is performed between the start time and the time of the reenacting point is displayed. Therefore, the sum of the quantities displayed in the “TOTAL RE-INCOMING CALLS” display field 78a and the “TOTAL FIRST-INCOMING CALLS” display field 78b is displayed in the “TOTAL INCOMING CALLS” display field 79.

In operation S101 illustrated in FIG. 5, the CPU 60g displays “0” as an initial value in each display field 71 to 77, 78a, 78b, and 79 of the playback screen 70 illustrated in FIG. 7. The CPU 60g also displays “00:00:00” as an initial value in the playback time display field 70d of the playback screen 70 illustrated in FIG. 7. The CPU 60g clears the date input field 70a of the playback screen 70 illustrated in FIG. 7. In addition, at the time of operation S101 illustrated in FIG. 5, clickable functions of the “START” button 70c and the “STATISTICS” button 70e of the playback screen 70 illustrated in FIG. 7 is disabled. After displaying the playback screen 70, the CPU 60g advances the process to operation S102 illustrated in FIG. 5.

In operation S102, the CPU 60g stands by until an instruction is issued by clicking any one of the “SET” button 70b, the “START” button 70c, and the “STATISTICS” button 70e in the playback screen 70 illustrated in FIG. 7, or an termination instruction to the playback tool 64 is issued. When operation S101 is executed just before operation S102, the CPU 60g stands by until an instruction is issued by clicking the “SET” button 70b in the playback screen 70 illustrated in FIG. 7, or the termination instruction to the playback tool 64 is issued, in operation S102. When an instruction is issued by clicking any one of each button 70b, 70c, and 70e in the playback screen 70 illustrated in FIG. 7, or the termination instruction to the playback tool 64 is issued (“Yes” in operation S102), the CPU 60g advances the process to operation S103.

In operation S103, the CPU 60g determines whether the instruction received from the operator is the termination instruction to the playback tool 64. When the instruction received from the operator in operation S102 is not the termination instruction to the playback tool 64 (“No” in operation S103), the CPU 60g branches the process from operation S103 to operation S104 illustrated in FIG. 6.

In operation S104, the CPU 60g determines whether the instruction received from the operator in operation S102 is an instruction for setting a date issued by clicking the “SET” button 70b illustrated in FIG. 7. When the instruction received from the operator in operation S102 is the instruction for setting a date by clicking the “SET” button 70b illustrated in FIG. 7 (“Yes” in operation S104), the CPU 60g advances the process from operation S104 to operation S105.

In operation S105, the CPU 60g extracts records from the event table 62 illustrated in FIG. 4 with the date inputted in the date input field 70a at the point when the “SET” button 70b illustrated in FIG. 7 is clicked as an extraction condition.

In operation S106, the CPU 60g enables the clickable function of the “START” button 70c in the playback screen 70 illustrated in FIG. 7. Thereafter, the CPU 60g returns the process to operation S102 illustrated in FIG. 5, and stands by until an instruction is issued from the operator. When the “START” button 70c has already been enabled, the CPU 60g performs nothing and returns the process to operation S102 illustrated in FIG. 5. It is because a first work table and a second work table, which will be discussed later, necessary for displaying changes in a connection status of a phone call have been generated at least once if the “START” button 70c has already been enabled.

On the other hand, when the instruction received from the operator in operation S102 illustrated in FIG. 5 is not the instruction for setting a date by clicking the “SET” button 70b illustrated in FIG. 7 (“No” in operation S104), the CPU 60g branches the process from operation S104 to operation S107 illustrated in FIG. 6.

In operation S107, the CPU 60g determines whether the instruction received from the operator in operation S102 illustrated in FIG. 5 is an instruction for starting the playback process by clicking the “START” button 70c illustrated in FIG. 7. When the instruction received from the operator in operation S102 is the instruction for starting the playback process by clicking the “START” button 70c (“Yes” in operation S107), the CPU 60g advances the process from operation S107 to operation 5108.

In operation S108, the CPU 60g generates work tables. The work tables generated here include the first work table, the second work table, and a third work table.

The first work table temporarily stores the quantities each of which is displayed in the display fields 71 to 75 illustrated in FIG. 7.

The second work table temporarily stores the quantities each of which is displayed in the display fields 76, 77, 78a, 78b, and 79 illustrated in FIG. 7.

The third work table stores the frequency distribution of the abandoned calls and the answered calls in the set date. In the embodiment, it is assumed that a quantity of the third work tables to be generated is the same as a quantity of contact points of the organization using the telephony system.

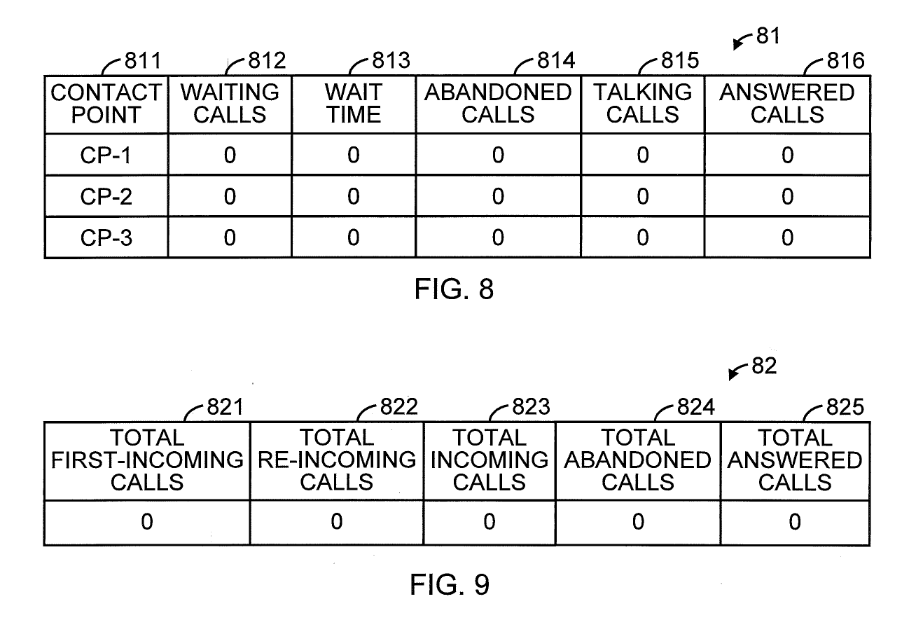

FIG. 8 is a diagram illustrating an example of a data configuration of a first work table according to an embodiment of the present invention.

The first work table 81 has records, a quantity of which is the same as a quantity of contact points of the organization using the telephony system. Each record includes a “CONTACT POINT” field 811, a “WAITING CALLS” field 812, a “WAIT TIME” field 813, an “ABANDONED CALLS” field 814, a “TALKING CALLS” field 815, and an “ANSWERED CALLS” field 816. In each field, contact point identifier, a quantity of waiting calls, wait time, a quantity of abandoned calls, a quantity of talking calls, and a quantity of answered calls are stored respectively for each contact point. When the first work table 81 is generated, “0” is stored in each field of each record as an initial value.

FIG. 9 is a diagram illustrating an example of a data configuration of a second work table according to an embodiment of the present invention.

The second work table 82 has one record. The record includes a “TOTAL FIRST-INCOMING CALLS” field 821, a “TOTAL RE-INCOMING CALLS” field 822, a “TOTAL INCOMING CALLS” field 823, a “TOTAL ABANDONED CALLS” field 824, and a “TOTAL ANSWERED CALLS” field 825. In each field, the total quantity of first-incoming calls, the total quantity of second or later incoming calls, the total quantity of incoming calls, the total quantity of abandoned calls in all the contact points, and the total quantity of answered calls in all the contact points are stored respectively. When the second work table 82 is generated, “0” is stored in each field of the record as an initial value.

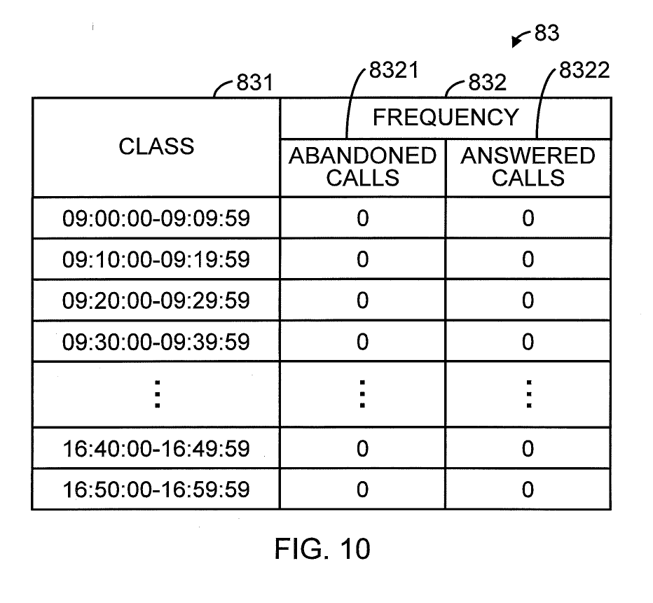

FIG. 10 is a diagram illustrating an example of a data configuration of a third work table according to an embodiment of the present invention.

The frequency distribution is obtained by equally dividing a contact point operation time of the set date, from 9 o'clock to 17 o'clock for example, to set a plurality of classes (intervals) of 10 minutes for example, and counting up a quantity of the phone calls belonging to each class. The third work table 83 includes records, a quantity of which is the same as a quantity of the classes. Each record includes a “CLASS” field 831 and a “FREQUENCY” field 832. The “CLASS” field 831 is a field in which the start time and end time of the class (interval) is stored. The “FREQUENCY” field 832 is a field in which a quantity of the phone calls belonging to the class is stored as the frequency. In the embodiment, the “FREQUENCY” field 832 is further divided into an “ABANDONED CALLS” sub-field 8321 and an “ANSWERED CALLS” sub-field 8322. In each sub-field, a quantity of abandoned calls and a quantity of answered calls are respectively stored as the frequency. When the third work table 83 is generated, “0” is stored in each sub-field of each record as an initial value.

After generating the first work table 81, the second work table 82, and the third work table 83 illustrated in FIGS. 8 to 10, respectively, in operation S108 illustrated in FIG. 6, the CPU 60g advances the process to operation S109.

In operation S109, the CPU 60g invokes a playback subroutine and executes it. The playback subroutine describes a process for changing contents of the playback screen 70.

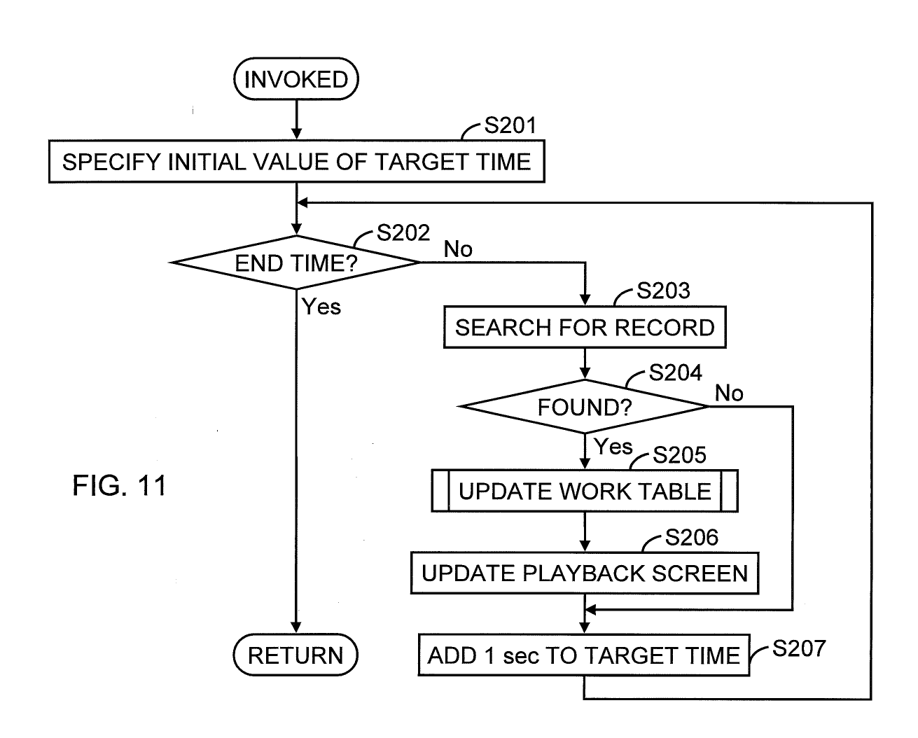

FIG. 11 is a flowchart illustrating an operation flow of a playback subroutine according to an embodiment of the present invention.

In the first operation S201, after starting the playback subroutine, the CPU 60g specifies a predefined start time (for example, 9 o'clock 00 minute 00 second) as an initial value of a process target time. Thereafter, the CPU 60g advances the process to operation S202.

In operation S202, the CPU 60g determines whether the process target time is a predefined end time (for example, 17 o'clock 00 minute 00 second). When the process target time is not the predefined end time (“No” in operation S202), the CPU 60g branches the process from operation S202 to operation S203.

In operation S203, the CPU 60g searches for records having the same value as the process target time in the “TIME” field 622 (refer to FIG. 4) from among the records extracted in operation S105 illustrated in FIG. 6.

In the next operation S204, the CPU 60g determines whether one or more records having the same value as the process target time in the “TIME” field 622 are found by the search in operation 5203. When no record having the same value as the process target time in the “TIME” field 622 is found (“No” in operation S204), the CPU 60g branches the process from operation S204 to operation S207. On the other hand, when one or more records having the same value as the process target time in the “TIME” field 622 are found (“Yes” in operation S204), the CPU 60g advances the process from operation S204 to operation S205.

In operation S205, the CPU 60g invokes a work table update subroutine and executes it. The work table update subroutine defines a process for updating the first work table 81, the second work table 82, and the third work table 83 generated in operation S108 illustrated in FIG. 6 in accordance with by the search in operation S203.

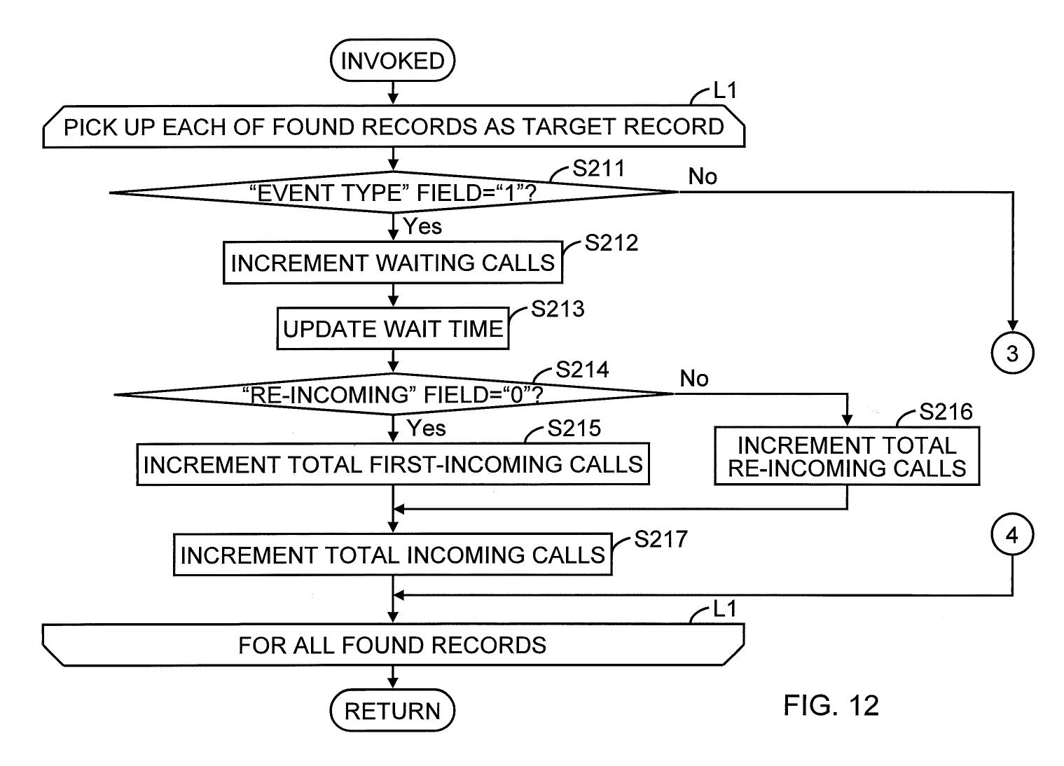

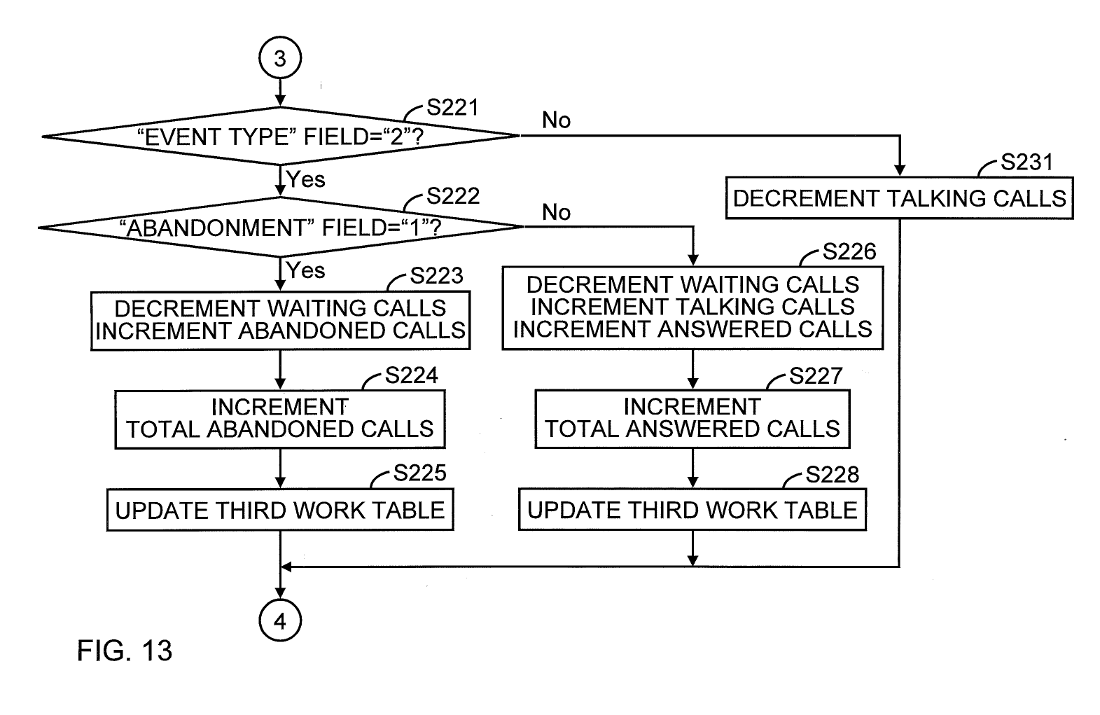

FIGS. 12 and 13 are flowcharts illustrating an operation flow of a work table update subroutine according to an embodiment of the present invention.

After starting the work table update subroutine, the CPU 60g executes a first loop L1. In the first loop L1, the CPU 60g picks up the one or more records found by the search in operation S203 illustrated in FIG. 11 one by one sequentially as a target record. The CPU 60g executes operations S211 to 5217, S221 to S228, and S231 on one record picked up as the target record.

In operation S211, the CPU 60g determines whether the value of the “EVENT TYPE” field 623 (refer to FIG. 4) of the target record is “1” (incoming call). When the value of the “EVENT TYPE” field 623 of the target record is “1” (incoming call) (“Yes” in operation S211), the CPU 60g advances the process from operation S211 to operation S212.

In operation S212, the CPU 60g identifies a record having the same contact point identifier as that of the target record from among each record of the first work table 81 illustrated in FIG. 8. Next, the CPU 60g increments the value of the “WAITING CALLS” field 812 of the identified record by “1”.

In operation S213, the CPU 60g updates the wait time by overwriting the value of the “WAIT TIME” field 627 of the record in which a quantity of the waiting calls has been incremented in operation S212, with the value of the “WAIT TIME” field 627 of the target record.

In operation 5214, the CPU 60g determines whether the value of the “RE-INCOMING” field 625 of the target record is “0” (first-incoming call). When the value of the “RE-INCOMING” field 625 of the target record is “0 (first-incoming call) (“Yes” in operation S214), the CPU 60g advances the process from operation S214 to operation S215.

In operation S215, the CPU 60g increments the value of “TOTAL FIRST-INCOMING CALLS” field 821 of the record of the second work table 82 illustrated in FIG. 9 by “1”. Thereafter, the CPU 60g advances the process to operation S217.

On the other hand, when the value of the “RE-INCOMING” field 625 of the target record is not “0” (first-incoming call) (“No” in operation S214), in other words, when the value of the “RE-INCOMING” field 625 of the target record is “1” (re-incoming call), the CPU 60g branches the process from operation S214 to operation S216.

In operation S216, the CPU 60g increments the value of “TOTAL RE-INCOMING CALLS” field 822 of the record of the second work table 82 illustrated in FIG. 9 by “1”. Thereafter, the CPU 60g advances the process to operation S217.

In operation S217, the CPU 60g increments the value of “TOTAL INCOMING CALLS” field 823 of the record of the second work table 82 illustrated in FIG. 9 by “1”. Thereafter, the CPU 60g completes a cycle of the target record in the first loop L1.

On the other hand, when the value of the “EVENT TYPE” field 623 of the target record is not “1” (incoming call) (“No” in operation S211), the CPU 60g branches the process from operation S211 to operation S221 illustrated in FIG. 13.

In operation S221, the CPU 60g determines whether the value of the “EVENT TYPE” field 623 of the target record is “2” (answered call). When the value of the “EVENT TYPE” field 623 of the target record is “2” (answered call) (“Yes” in operation S221), the CPU 60g advances the process from operation S221 to operation S222.

In operation S222, the CPU 60g determines whether the value of the “ABANDONMENT” field 626 of the target record is “1” (abandoned call). When the value of the “ABANDONMENT” field 626 of the target record is “1” (abandoned call) (“Yes” in operation S222), the CPU 60g advances the process from operation S222 to operation S223.

In operation S223, the CPU 60g identifies a record having the same contact point identifier as that of the target record from among each record of the first work table 81 illustrated in FIG. 8. Next, the CPU 60g decrements the value of the “WAITING CALLS” field 812 of the identified record by “1”, and increments the value of the “ABANDONED CALLS” field 814 of the same record by “1”.

In operation S224, the CPU 60g increments the value of “TOTAL ABANDONED CALLS” field 824 of the record of the second work table 82 illustrated in FIG. 9 by “1”.

In operation S225, the CPU 60g identifies a third work table 83 corresponding to the contact point identifier contained in the target record from among the third work tables 83 (refer to FIG. 10) corresponding to each of the plurality of contact points included in the organization using the telephony system. Next, the CPU 60g identifies the record of a class to which the value of the “TIME” field 622 in the target record belongs, from among records of the identified third work table 83. Furthermore, the CPU 60g increments the value of the “ABANDONED CALLS” sub-field 8321 of the identified record by “1”. Thereafter, the CPU 60g completes a cycle of the target record in the first loop L1.

On the other hand, when the value of the “ABANDONMENT” field 626 of the target record is not “1” (abandoned call) (“No” in operation S222), in other words, when the value of the “ABANDONMENT” field 626 of the target record is “0” (Answered call), the CPU 60g branches the process from operation S222 to operation S226.

In operation S226, the CPU 60g identifies a record having the same contact point identifier as that of the target record from among each record in the first work table 81 illustrated in FIG. 8. Next, the CPU 60g decrements the value of the “WAITING CALLS” field 812 of the identified record by “1”, and increments the values of the “TALKING CALLS” field 815 and the “ANSWERED CALLS” field 816 of the same record by “1” respectively.

In operation S227, the CPU 60g increments the value of “TOTAL ANSWERED CALLS” field 825 of the record of the second work table 82 illustrated in FIG. 9 by “1”.

In operation S228, the CPU 60g identifies a third work table 83 corresponding to the contact point identifier contained in the target record from among the third work tables 83 (refer to FIG. 10) corresponding to each of the plurality of contact points included in the organization using the telephony system. Next, the CPU 60g identifies the record of a class to which the value of the “TIME” field 622 in the target record belongs, from among records of the identified third work table 83. Furthermore, the CPU 60g increments the value of the “ANSWERED CALLS” sub-field 8322 of the identified record by “1”. Thereafter, the CPU 60g completes a cycle of the target record in the first loop L1.

On the other hand, when the value of the “EVENT TYPE” field 623 of the target record is not “2” (answered call) (“No” in operation S221), in other words, when the value of the “EVENT TYPE” field 623 of the target record is “3” (clear-back call), the CPU 60g branches the process from operation S221 to operation S231.

In operation S231, the CPU 60g identifies a record having the same contact point identifier as that of the target record from among each record in the first work table 81 illustrated in FIG. 8. Next, the CPU 60g decrements the value of the “TALKING CALLS” field 815 of the identified record by “1”. Thereafter, the CPU 60g completes a cycle of the target record in the first loop L1.

When the CPU 60g has executed operations S211 to S217, S221 to S228, and S231 for all the records found by the search in operation S203 illustrated in FIG. 11, the CPU 60g leaves the first loop L1 and terminates the work table update subroutine illustrated in FIGS. 12 and 13.

When the work table update subroutine terminates, the CPU 60g returns to the playback process illustrated in FIG. 11 and advances the process to operation S206.

In operation S206, the CPU 60g updates the contents of the display fields 71 to 75 and the display fields 76, 77, 78a, 78b, and 79 on the playback screen 70 illustrated in FIG. 7, in accordance with the contents of the first work table 81 and second work table 82 illustrated in FIGS. 8 and 9. The CPU 60g also updates the time in the playback time display field 70d on the playback screen 70 illustrated in FIG. 7 to the process target time. Thereafter, the CPU 60g advances the process to operation S207.

In operation S207, the CPU 60g adds one second to the process target time. Thereafter, the CPU 60g returns the process to operation S202.

On the other hand, when the process target time is the predefined end time (“Yes” in operation S202), the CPU 60g terminates the playback subroutine illustrated in FIG. 11.

Therefore, according to the above discussed playback subroutine, each time the reenacting point (process target time) reaches the time contained in the record extracted in operation S105 illustrated in FIG. 6, the contents of the first work table 81 and the second work table 82 illustrated in FIGS. 8 and 9 are updated, and also the contents of the display fields and the display fields on the playback screen 70 illustrated in FIG. 7 are updated. Each time the reenacting point (process target time) reaches the time contained in the record of the answered type event among the records extracted in operation S105 illustrated in FIG. 6, “1” is added to the frequency of the class, corresponding to the time, of the third work table 83 illustrated in FIG. 10.

When the playback subroutine terminates, the CPU 60g returns to the main routine illustrated in FIGS. 5 and 6, and advances the process to operation S110 illustrated in FIG. 6.

The CPU 60g executing operations S101 to S109 and steps 201 to S207 corresponds to the above discussed display unit.

In operation S110, the CPU 60g enables the clickable function of the “STATISTICS” button 70e in the playback screen 70 illustrated in FIG. 7. Thereafter, the CPU 60g returns the process to operation S102 illustrated in FIG. 5, and stands by until an instruction is issued from the operator. However, when the “STATISTICS” button 70e has already been enabled, the CPU 60g performs nothing and returns the process to operation S102 illustrated in FIG. 5. It is because the third work table 83 necessary for displaying a graph of the frequency distribution has been generated at least once if the “STATISTICS” button 70e has already been enabled.

On the other hand, when the instruction received from the operator in operation S102 is not the instruction for starting the playback process by clicking the “START” button 70c illustrated in FIG. 7 (“No” in operation S107), in other words, when the instruction is for displaying the graph by clicking the “STATISTICS” button 70e, the CPU 60g branches the process from operation S107 to operation S111.

In operation S111, the CPU 60g displays a screen including the frequency distribution graph of the abandoned calls and the answered calls in accordance with the contents of the third work table 83 illustrated in FIG. 10.

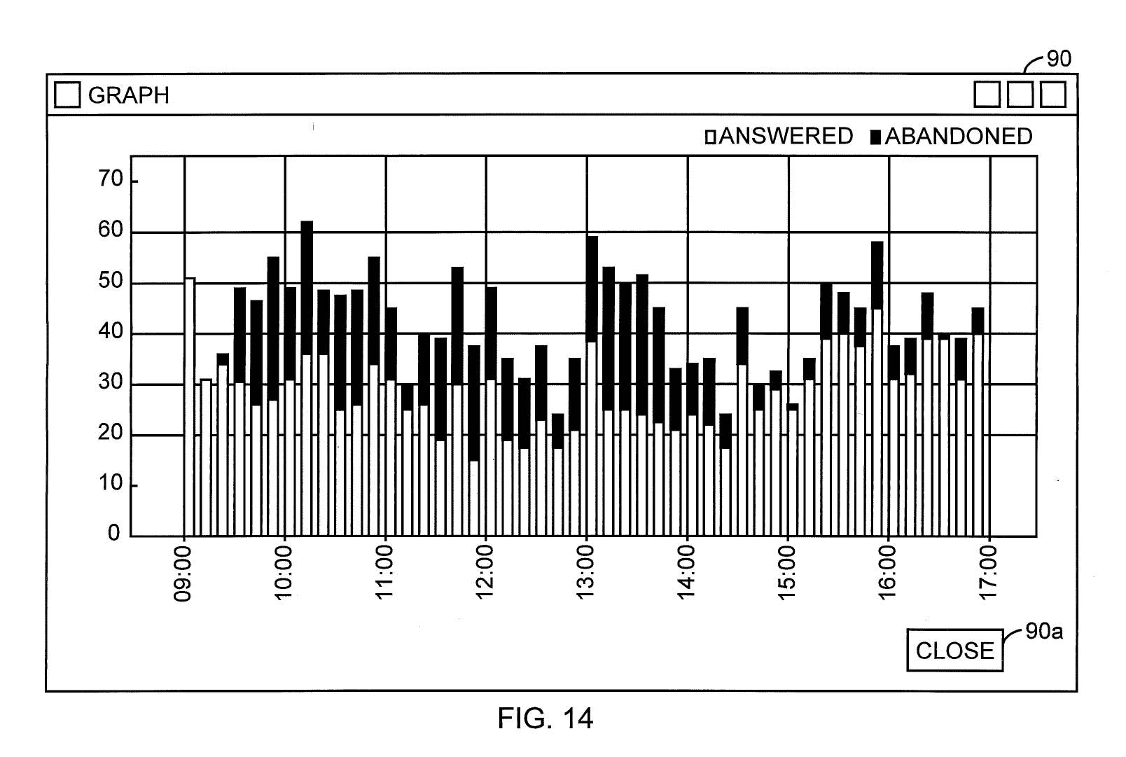

FIG. 14 is a diagram illustrating an example of a screen including a frequency distribution graph according to an embodiment of the present invention.

In the graph illustrated in FIG. 14, the vertical axis indicates frequency and the horizontal axis indicates class. The frequency of each class is illustrated as a bar graph, and the graph illustrated in FIG. 14 is a histogram. In FIG. 14, the frequency of the answered calls is represented by white bar graph and the frequency of the abandoned calls is represented by black bar graph. Since the white bar graph is placed under the black bar graph, it may be easy to understand the difference between the frequencies of the abandoned calls and the answered calls. The screen 90 including the histogram also includes a “CLOSE” button 90a for closing the screen.

After displaying the screen 90 illustrated in FIG. 14, the CPU 60g stands by until the “CLOSE” button 90a is clicked. When the “CLOSE” button 90a is clicked, the CPU 60g returns the process to operation S102 illustrated in FIG. 5, and stands by until an instruction is issued from the operator.

On the other hand, in operation S103, when the instruction received from the operator in operation S102 is the termination instruction to the playback tool 64 (“Yes” in operation S103), the CPU 60g terminates the main routine illustrated in FIGS. 5 and 6.

As discussed above, according to the management machine 60 of this embodiment, when the “START” button 70c is clicked after any date in the past is inputted in the date input field 70a on the playback screen 70 illustrated in FIG. 7 and the “SET” button 70b is clicked (“No” in operation S103, “No” in operation S104, and “Yes” in operation S107), condition in which a quantity of waiting calls, a quantity of abandoned calls, a quantity of talking calls, and a quantity of answered calls are increasing or decreasing is reenacted in order of time for each contact point (operations S108, S109, S201 to S207).

Therefore, when clicking the “SET” button 70b after inputting any date in the past into the date input field 70a on the playback screen 70 illustrated in FIG. 7 and further clicking the “START” button 70c, the administrator (or operator) of the telephony system may check changes in a connection status of a phone call on any date.

In the above discussed embodiment, sets of the “WAITING CALLS” display field 71, the “WAIT TIME” display field 72, the “ABANDONED CALLS” display field 73, the “TALKING CALLS” display field 74, and the “ANSWERED CALLS” display field 75 are included in the playback screen 70, and a quantity of the sets is the same as a quantity of the contact points of the organization which uses the telephony system as illustrated in FIG. 7. Alternatively, a quantity of the sets of display fields 71 to 75 included in the playback screen 70 may be the same as a quantity of the call takers. In this case, the first work table 81 illustrated in FIG. 8 may include records, a quantity of which is the same as a quantity of the call takers. In the playback screen 70, the sets of the display fields 71 to 75 may be divided into groups, each of which corresponds to a contact point which the call takers belong to. In this case, for displaying the groups, each record of the first work table 81 may further include a field storing the contact point identifier capable of identifying the contact point to which the call taker belongs.

In the above discussed embodiment, the frequency distribution is illustrated by histogram (bar graph). However, the frequency distribution may be a line graph. The frequency distribution may be illustrated on a coordinate system for each contact point, in other words, for each third work table 83, or graphs of all the contact points may be illustrated on the same coordinate system by using different colors.

In the above discussed embodiment, each unit 60c to 60h in the management machine 60 may be consisted of software elements and hardware elements, or may be consisted of only hardware elements.

The software elements may be interface programs, driver programs, tables, data, and a combination of some of them. These elements may be stored in a computer-readable medium discussed below, and also may be firmware fixedly embedded in a storage device such as a read only memory (ROM) and an large scale integration (LSI).

The hardware elements may be field programmable gate arrays (FPGA), application specific integrated circuits (ASIC), gate arrays, a combination of logic gates, signal processing circuits, analog circuits, and other circuits. Among them, the logic gate may include AND, OR, NOT, NAND, NOR, flip-flop, and counter circuits. The signal processing circuit may include circuit elements for executing addition, multiplication, division, inversion, product-sum operation, differentiation, integration, and the like. The analog circuit may include circuit elements for executing amplification, addition, multiplication, differentiation, integration, and the like.

Elements constituting each unit 60c to 60h in the above discussed management machine 60 are not limited to the elements discussed above, and may be other elements equivalent to the elements discussed above.

In the above discussed embodiment, any of the operating system 61, the event table 62, the table generating module 63, the playback tool 64, and the above discussed software elements in the management machine 60 may include elements such as software components, components by procedural language, object-oriented software components, class components, components managed as tasks, components managed as processes, functions, attributes, procedures, subroutines (software routines), pieces or parts of program codes, drivers, firmware, microcodes, codes, code segments, extra segments, stack segments, program areas, data areas, data, databases, data structures, fields, records, tables, matrix tables, arrays, variables, and parameters.

Any of the operating system 61, the event table 62, the table generating module 63, the playback tool 64 in the above discussed management machine 60, and the above discussed software elements may be written in C language, C++, JAVA (trademark of Sun Microsystems, Inc., USA), Visual Basic (trademark of Microsoft Corporation, USA), Perl, Ruby, and many other programming languages.

Instructions, codes, and data included in the operating system 61, the event table 62, the table generating module 63, the playback tool 64 in the above discussed management machine 60, and the above discussed software elements may be transmitted or loaded to a computer or a computer installed in a machine or a device, via a wired network card and a wired network or via a wireless card and a wireless network.

In the above discussed transmission or loading, a data signal is, for example, set into a carrier wave to be transferred on a wired network or a wireless network. However, instead of using the above mentioned carrier wave, the data signal may be transmitted as a so-called baseband signal without change. Such carrier wave is transmitted in electric, magnetic, or electromagnetic form, or optical, sonic, or another type of form.

Here, the wired network or the wireless network is, for example, a phone line, a network line, a cable including an optical cable and a metal cable, a wireless link, a mobile phone access line, a personal handyphone system (PHS) network, a wireless local area network (LAN), Bluetooth (trademark of the Bluetooth special interest group), vehicle-mounted type wireless communication including dedicated short range communication (DSRC), and a network including some of these. The data signal transfers data including instructions, codes, and data to a node or an element on the network.

Elements constituting the operating system 61, the event table 62, the table generating module 63, the playback tool 64 in the above discussed management machine 60, and elements constituting the above discussed software elements are not limited to the elements discussed above, and may be other elements equivalent to the elements discussed above.

Any of the functions in the above discussed embodiment may be encoded and stored in a storage area of a computer-readable medium. In this case, a program for realizing the function is provided to a computer or a computer installed in a machine or a device, via the computer-readable medium. The computer or the computer installed in a machine or a device may realize the function by reading the program from the storage area of the computer-readable medium and executing the program.

Here, the computer-readable medium is a recording medium for accumulating information such as program and data by electric, magnetic, optical, chemical, physical, or mechanical action, and holding the information in a computer-readable status.

The electric or magnetic action may include, for example, an action for writing data into an element on a read only memory (ROM) consisted of fuses. The magnetic or physical action may include, for example, an action for developing a latent image on a paper medium by supplying a toner. The data recorded on a paper medium may be read optically, for example. The optical and chemical action may include, for example, an action for forming a thin film or forming concaves and convexes on a substrate. The data recorded in a form of concaves and convexes may be read optically, for example. The chemical action may include, for example, an oxidation-reduction reaction on a substrate, an oxide film formation or a nitride film formation on a semiconductor substrate, or a photoresist development. The physical or mechanical action may include, for example, an action for forming concaves and convexes on an embossed card or making punched holes in a paper medium.

The computer-readable media may be detachably mounted in a computer or a computer installed in a machine or a device. The detachable computer-readable media may include, DVD (including DVD-R, DVD-RW, DVD-ROM, DVD-RAM), +R/+WR, BD (including BD-R, BD-RE, BD-ROM), compact disk (CD) (including CD-R, CD-RW, CD-ROM), magneto optical (MO) disk, other optical disk media, flexible disk including floppy disk (floppy is a trademark of Hitachi, Ltd.), other magnetic disk media, memory card including Compact Flash (trademark of SanDisk Corp., USA), SmartMedia (trademark of Toshiba Corporation), SD card (trademark of SanDisk Corp., USA, Matsushita Electric Industrial Co., Ltd., and Toshiba Corporation), memory stick (trademark of Sony Corporation), MMC (trademark of Siemens Corp., USA and SanDisk Corp., USA), and the like), magnetic tape, other tape media, and storage devices containing any of these media. These storage devices may further contain dynamic random access memory (DRAM) or static random access memory (SRAM).

The computer-readable media may be fixedly mounted in a computer or a computer installed in a machine or a device. This type of computer-readable media may include hard disk, DRAM, SRAM, ROM, electronically erasable and programmable read only memory (EEPROM), flash memory, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A phone call status reenactment device for reenacting connection status of a phone call, the phone call status reenactment device comprising:
a storage for storing event data for each event in which connection status of a phone call has changed, the event data including time data indicating a time when the connection status changed and type data indicating a type of event; and
a display unit for displaying data on connection status in response to an instruction, the data on connection status being displayed in order of time in accordance with the event data stored in the storage, the data on connection status including a quantity of phone calls before answered by a phone call taker, a quantity of phone calls ended without answered by a phone call taker, and a quantity of phone calls answered by a phone call taker.

2. The phone call status reenactment device of claim 1, wherein
the event data further includes a contact point identifier capable of identifying a contact point, and
the display unit displays the data on connection status for each contact point in accordance with the contact point identifier.

3. The phone call status reenactment device of claim 1, wherein
the data on connection status further includes a quantity of phone calls currently answered.

4. The phone call status reenactment device of claim 2, wherein
the data on connection status further includes a quantity of phone calls currently answered.

5. A phone call status reenactment method executed by a phone call status reenactment device for reenacting phone call status, the phone call status reenactment method comprising:
storing event data for each event in which connection status of a phone call has changed, the event data including time data indicating a time when the connection status changed and type data indicating a type of event; and
displaying data on connection status in response to an instruction, the data on connection status being displayed in order of time in accordance with stored event data, the data on connection status including a quantity of phone calls before answered by a phone call taker, a quantity of phone calls ended without answered by a phone call taker, and a quantity of phone calls answered by a phone call taker.
